(19) United States
(12) Patent Application Publication
(10) Pub. No.: US 2011/0102304 A1
(43) Pub. Date: May 5, 2011

(54) PORTABLE ELECTRONIC DISPLAY SYSTEM FOR TEXTILE APPLICATIONS

(76) Inventor: Anders Kristofer Nelson, San Jose, CA (US)

(21) Appl. No.: 12/612,576

(22) Filed: Nov. 4, 2009

(51) Int. Cl. G09G 3/14

(52) U.S. Cl. 345/46

(57) ABSTRACT

A portable electronic display system includes a display module having at least one circuit board with an LED driver, light emitting diodes attached to the circuit board, and at least one terminal board in communication with the LED driver; a processor board having a memory storage element, which is in communication with the terminal board; a textile substrate having a pocket with a light-transmitting cover surface, the pocket being configured to house the display module, such that the light emitting diodes are adjacent the light-transmitting cover surface; a battery, which is in electrical communication with the terminal board; and means for flexibly connecting the circuit board, the terminal board, and the processor board; and wherein the memory storage element provides instructions to the LED drivers to selectively control the light emitting diodes and produce an image. The textile may be an article to be worn or carried.

### TECHNICAL FIELD

The present disclosure is directed to electronic displays that may be incorporated within a textile construction, such as a garment to be worn or an article to be carried. The display includes a plurality of light emitting diodes connected to rigid printed circuit boards, the circuit boards being connected to each other, to a processor board, and to a power source by flexible electrical connections.

### BACKGROUND

For years, manufacturers have developed and introduced a wide variety of products including one or more lighting elements. Lighting elements are sometimes used to illuminate a consumer product, a wearable garment or accessory, novelty item, or the like. By way of example, manufacturers have incorporated illumination components into refrigerators, microwaves, vacuum cleaners, headbands, baseball caps, key chains, glow-sticks, children's toys and balls, and a host of other products.

More recently, traditional light bulbs have been replaced in many applications by durable light emitting diodes (or “LEDs”). Light emitting diodes, which operate on the principle of electroluminescence of a semiconductor diode, offer several advantages over traditional white-light bulbs. Some of these advantages include lower energy consumption, longer lifetime, improved robustness, smaller size, and faster switching. Some disadvantages of LEDs are cost per lumen (as compared with a conventional bulb), temperature dependence, and voltage sensitivity. Because the advantages so often out-weigh the disadvantages, LEDs are now widely used in a large number of different applications, such as lighting for buildings, cars, and motorcycles; backlighting for liquid crystal display (LCD) televisions and lightweight laptop computers; and specialty lighting for signs, theater aisles, and the like.

Several manufacturers have also begun to use LEDs for illumination and decoration in apparel or accessory applications. The conventional thinking about installing LEDs onto textile substrates has been that the circuit boards carrying the LEDs must be flexible to maintain the drape and hand of the substrate. Flexible printed circuit boards, in addition to being flexible and ductile, offer the benefits of being lightweight, soft, thin, and relatively small. Unfortunately, these properties are achieved at a relatively high cost, as compared with rigid circuit boards, and often at the expense of long-term durability.

Rigid printed circuit boards offer durability, while being economical. In addition, rigid circuit boards provide superior heat dissipation and tolerance of high temperatures, especially when the attached light emitting diodes are operating at full brightness. Moreover, these printed circuit boards are easily manufactured by machine, further contributing to their reduced costs per unit.

What is needed and has been heretofore unavailable in the industry is a portable electronic display system for textile articles that incorporate rigid circuit boards connected by flexible electrical connections, in which the flexible electrical connections provide the necessary flexibility in the display module as a whole. Such a system is provided herein.

### SUMMARY

A portable electronic display system is provided, which includes a display module having at least one circuit board with an LED driver, light emitting diodes attached to the circuit board, and at least one terminal board in communication with the LED driver; a processor board having a memory storage element, which is in communication with the terminal board; a textile substrate having a pocket with a light-transmitting cover surface, the pocket being configured to house the display module, such that the light emitting diodes are adjacent the light-transmitting cover surface; a battery, which is in electrical communication with the terminal board; and means for flexibly connecting the circuit board, the terminal board, and the processor board; wherein the memory storage element provides instructions to the LED drivers to selectively control the light emitting diodes and produce an image.

The displayed image may be a static image or a moving image formed from either single-color diodes, multi-color diodes, or a combination thereof. In one aspect, the diodes have a brightness of between about 80 and about 300 millicandelas.

According to one aspect, the flexible electrical connection means are wires. In another aspect, the flexible electrical connection means are flexible circuit boards.

The memory storage element may be a permanent memory storage unit or a removable memory card.

The light-transmitting cover surface of the display module pocket is one of a vinyl material, a plastic material, and a textile material, such as a chiffon. The pocket may be outfitted with a reclosable opening to permit conveyance of the display module therethrough. The opening may be provided with one of a hook-and-loop closure, a hook-and-eye closure, a snap closure, and a zipper. Hook-and-loop closures are used in one practice of the disclosure.

The processor board may include one or more user-interface elements for selectively altering the display image. Such elements may be in the form of a depressible button or a rotatable switch.

The battery is portable and rechargeable. In one aspect, the inner surface of the textile is provided with a pouch, which is configured to hold the battery. The processor board may be held in the same pouch with the battery, for convenience.

The textile substrate may be configured as an article to be worn or carried by a user.

### BRIEF DESCRIPTION OF THE DRAWINGS

A full and detailed disclosure is set forth in the accompanying specification, with reference made to the appended figures, in which:

FIG. 1 is a block diagram of a portable electronic display system, according to the teachings herein;

FIG. 2 is a flow chart, showing operation of the portable electronic display system of FIG. 1;

FIG. 3A is a partial plan view of a display module and a processor board, according to the teachings herein, as viewed from the back;

FIG. 3B is a partial plan view of the display module and the processor board of FIG. 3A, according to the teachings herein, as viewed from the front;

FIG. 4A is a plan view of a display module having a remotely located processor board (not shown), the display module being viewed from the back;

FIG. 4B is plan view of a portable electronic display system, having the display module of FIG. 4A, and further including a remotely located processor board and battery, the display system being viewed from the front;

FIG. 5A is a perspective view of a pocket housing the display module of FIG. 4B, the pocket being oriented in an open position;

FIG. 5B is a perspective view of the pocket of FIG. 5A, in which the pocket is oriented in a closed position;

FIG. 6 is a perspective view of an exemplary jacket, in which the portable electronic display system of the present disclosure is embedded; and

FIG. 7 is a perspective view of an exemplary messenger bag, in which the portable electronic display system of the present disclosure is embedded.

### DETAILED DESCRIPTION

To provide an overall understanding of the invention, certain illustrative embodiments will now be described, including various applications for the present portable electronic display system. However, it will be understood by those of ordinary skill in the art that the methods and systems described herein may be suitably adapted to other environments where portable electronic displays may be desired.

As used herein, the term “LED” is used to describe any device that is capable of receiving an electrical signal and producing a color of light in response to the signal. Thus, the term “LED” should be understood to include light emitting diodes of all types, light emitting polymers, semiconductor dies that produce light in response to current, organic LEDs, electro-luminescent strips, silicon based structures that emit light, and other such devices. In one embodiment, an “LED” may refer to a single light emitting diode package having multiple semiconductor dies that are individually controlled. It should also be understood that the term “LED” does not restrict the package type of the LED. The term “LED” includes packaged LEDs, non-packaged LEDs, surface mount LEDs, chip-on-board LEDs, and LEDs of all other configurations. The term “LED” also includes LEDs packaged or associated with phosphor wherein the phosphor may convert energy from the LED to a different wavelength.

As described herein, the present disclosure is directed primarily to displays using surface-mount LEDs, although the principles may be equally applicable to other LED types. The display module and system herein employ a plurality of LEDs mounted directly to rigid printed circuit boards. The circuit boards may be made in a variety of dimensions, but are typically from about 0.5 inches to about 2 inches tall and could be from about 0.5 square inches to about 2 square inches.

In most instances, the LEDs are arranged linearly—that is, in uniform rows—although other specialized, or non-uniform, arrangements could instead be used if the intended design so dictates. One exemplary sized circuit board used in the present display system holds sixteen LEDs arranged in two uniformly spaced rows of eight. Another exemplary arrangement includes up to 64 LEDs on a single circuit board, the LEDs being positioned, for instance, in eight rows of eight LEDs, four rows of sixteen LEDs, or some irregular combination. The LEDs may be single- or multi-colored diodes, depending on design preferences of the user. The single color diodes may be white or some other color. The multi-color diodes may be of type having a red, a green, and a blue diode within a single component, in which case an exemplary circuit board may contain four components and a total of twelve diodes.

The term “illuminate” should be understood to refer to the production of a frequency of radiation by an illumination source with the intent to illuminate a space, environment, material, object, or other subject. The term “color” should be understood to refer to any frequency of radiation, or combination of different frequencies, within the visible light spectrum. The term “color,” as used herein, should also be understood to encompass frequencies in the infrared and ultraviolet areas of the spectrum, and in other areas of the electromagnetic spectrum where illumination sources may generate radiation.

As used herein, the term “processor” may refer to any system for processing electronic signals. A processor may include a microprocessor, microcontroller, programmable digital signal processor or other programmable device. The processor is the central component of a specialized printed circuit board, or “processor board.” The processor board may also include a memory storage element, such as described further herein, which is integrated with the processor board or which is in electronic communication with the processor. A typical size for the processor board may range from about 1 square inch to about 5 square inches. The processor board and the light emitting circuit boards are not required to be of the same dimensions.

A processor may also, or instead, include an application specific integrated circuit, a programmable gate array, programmable array logic, a programmable logic device, a digital signal processor, an analog-to-digital converter, a digital-to-analog converter, or any other device that may be configured to process electronic signals. In addition, a processor may include discrete circuitry such as passive or active analog components including resistors, capacitors, inductors, transistors, operational amplifiers, and so forth, as well as discrete digital components such as logic components, shift registers, latches, or any other separately packaged chip or other component for realizing a digital function. Any combination of the above circuits and components, whether packaged discretely, as a chip, as a chipset, or as a die, may be suitably adapted to use as a processor as described herein. Where a processor includes a programmable device such as the microprocessor or microcontroller mentioned above, the processor may further include computer executable code that controls operation of the programmable device. The processor board can also be configured to receive programming signals addressed to it.

The memory storage element may store algorithms or control programs for controlling the LEDs. The memory storage element, which may also store look-up tables, calibration data, or other values associated with the control signals, may be a permanent memory storage unit integrated with the processor board or may be a removable memory card. The memory storage element may be a read-only memory, a programmable memory, a programmable read-only memory, an electronically erasable programmable read-only memory, a random access memory, a dynamic random access memory, a double data rate random access memory, a Rambus direct random access memory, a flash memory, or any other volatile or non-volatile memory for storing program instructions, program data, address information, and program output. A program, for example, may store control signals that may be cascaded in series from one light-emitting circuit board to another (and so on), such that the signals for producing a desired display image are transmitted from a single memory storage element.

A user interface may also be associated with the processor board. The user interface may be used to select a program from the memory, modify a program from the memory, modify a program parameter from the memory, select an external signal for control of the LEDs, initiate a program, or provide other user interface solutions. The user interface may also be provided with an on/off switch. Alternately, the user may simply disconnect the battery from its wiring.

Each light emitting circuit board includes an LED driver. The LED driver generally regulates the current, voltage, and/or power through the LED, in response to signals received from the processor. The LED driver may be a pulse width modulator, pulse amplitude modulator, pulse displacement modulator, resistor ladder, current source, voltage source, voltage ladder, switch, transistor, voltage controller, or other controller. In one version contemplated herein, the LED driver is a pulse width modulator, which controls the brightness of sixteen individual LEDs (on a given circuit board) by varying the electrical current through the use of pulse width modulation.

The LED driver on the first light emitting board receives instructions (data) from the processor board. Based on the instructions, the LED driver selectively provides current from the flexible electrical connections to the individual LEDs on the first light emitting board. The first LED driver then conveys the instructions to the second LED driver, which then conveys the instructions to the third LED driver, and so forth in the series, until all of the light emitting circuit board drivers have received the instruction signals.

In selectively illuminating the individual LEDs, the amount of current to a given LED may result in an LED brightness ratio from zero out of 65,535 (not lit) to a maximum of about 65,535 out of 65,535, based on the maximum brightness ratings for the LED. In one aspect, the brightness may range from about 80 to about 300 millicandelas. By varying the current applied in this manner, a full range of gray-scale or multi-colored design images may be produced.

Further, the amount of current provided to a given LED may vary over time to produce a dynamic, or moving, design image. For example, at time=0 seconds, the brightness may be a certain value x, whereas, at time=0.01 seconds, the brightness may be a second value y, and so on. The design image may change at a certain time interval, which will be referred to herein as the image speed. If desired, the user interface at the processor board may be employed to vary the image speed. Common image speeds may be on the order of about 30 frames per second (or 33 milliseconds between changes) to about 60 frames per second (or about 17 milliseconds between changes), although a wide range of image speeds may be produced.

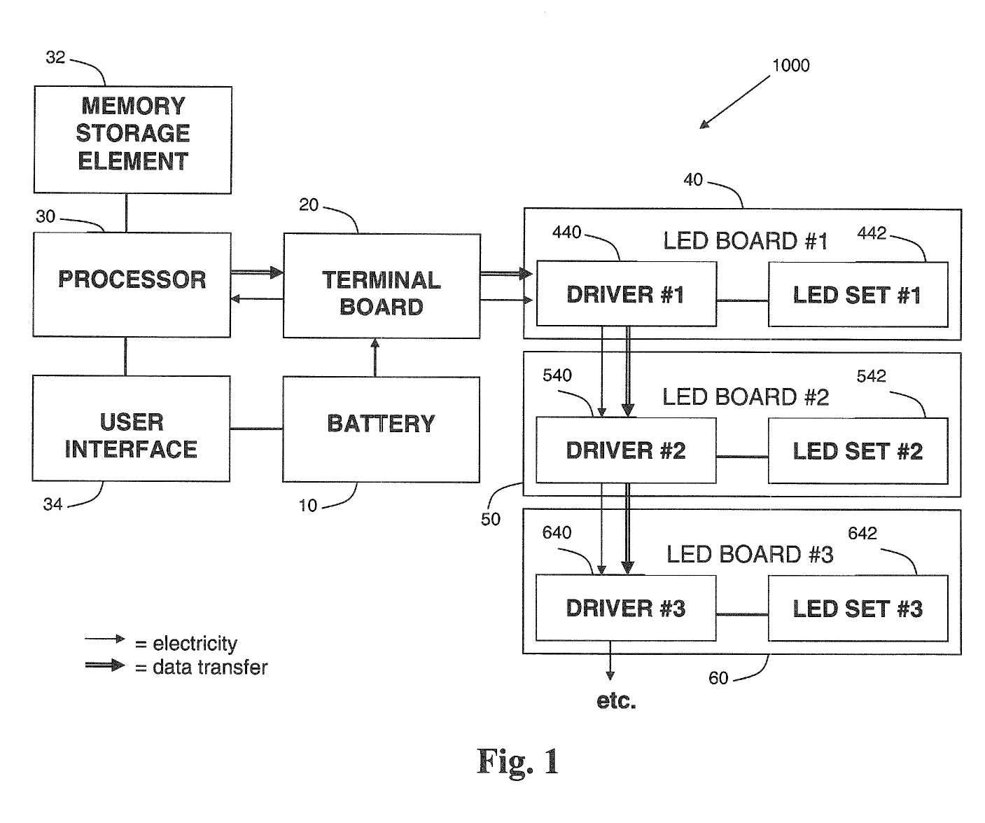

FIG. 1 is a block diagram of a portable electronic display system 1000, according to the teachings herein. The system 1000 may include a battery 10, a terminal board 20, a processor 30 having a memory storage element 32 and a user interface 34, and a plurality of light emitting circuit boards 40, 50, and 60 (identified as “LED boards” in FIG. 1). It should be understood that, while three light emitting circuit boards are illustrated, any different number of circuit boards may be employed, following the same principles described.

In general, the processor 30 may execute a program stored in the memory storage element 32 to generate signals that control stimulation of the LED sets 442, 542, 642. The signals may be converted by the drivers 440, 540, 640 located on each circuit board 40, 50, 60, respectively, into a form suitable for driving the light emitting diodes. The drivers 440, 540, 640, which receive the signals sequentially, may control the current, amplitude, duration, or waveform of the signals impressed on each light emitting diode of the sets 442, 542, 642. While the light emitting diodes are referred to collectively as a “set,” it should be understood that such nomenclature is intended to refer to the group of light emitting diodes on a particular LED board, but is not intended to imply that the diodes of a set are controlled collectively. Rather, each diode is independently and selectively controlled by signals from its respective driver.

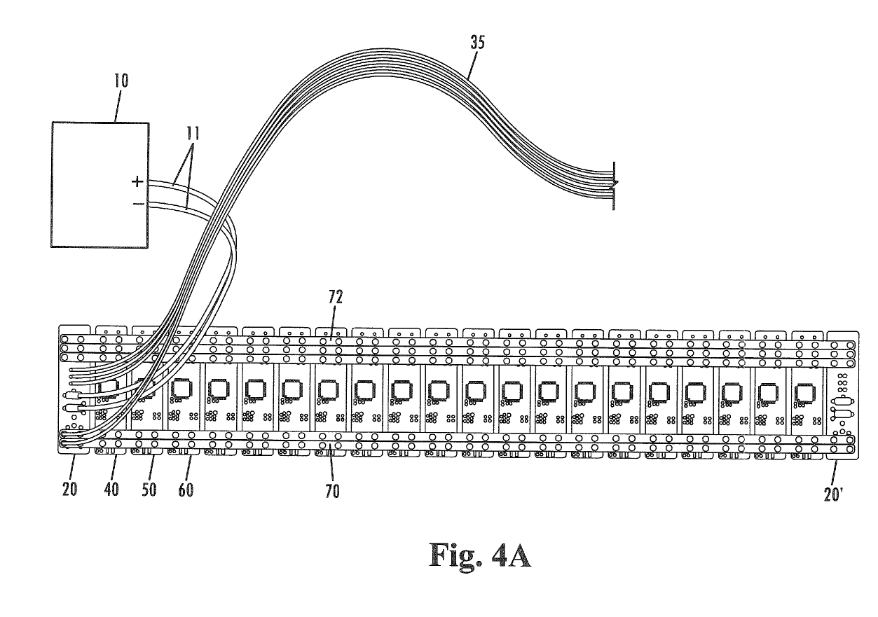

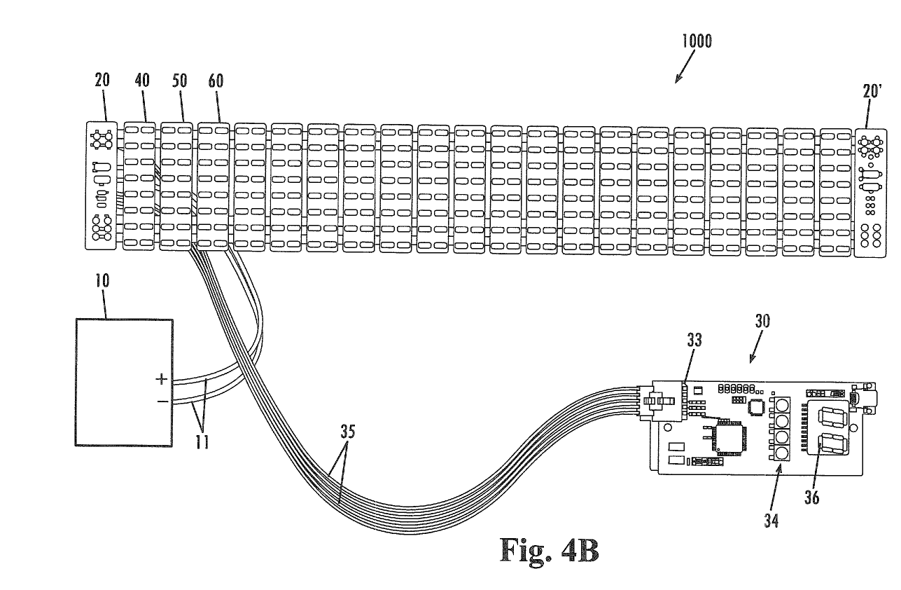

By manipulating the user interface 34 (seen more clearly in FIG. 4B), the user may turn the display system on and off, may select a display image from a library of stored images, or may manipulate the settings for creating the display image. For example, a display image may be modified from a static image to a moving image, or vice versa. Another possible adjustment is to alter the brightness of the display image. The rate with which the display image changes may also be adjusted from slow to fast, or vice versa. It may further be possible to modify the display instructions to cause the system to respond to stimuli, such as sound or touch.

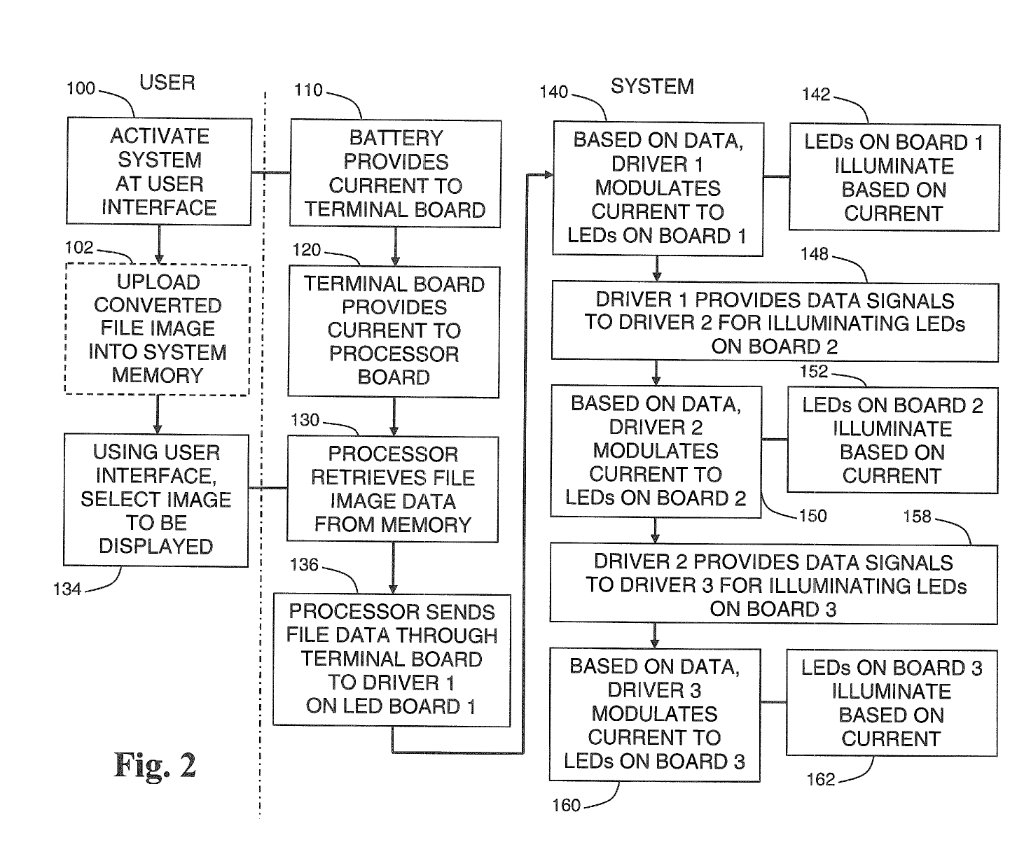

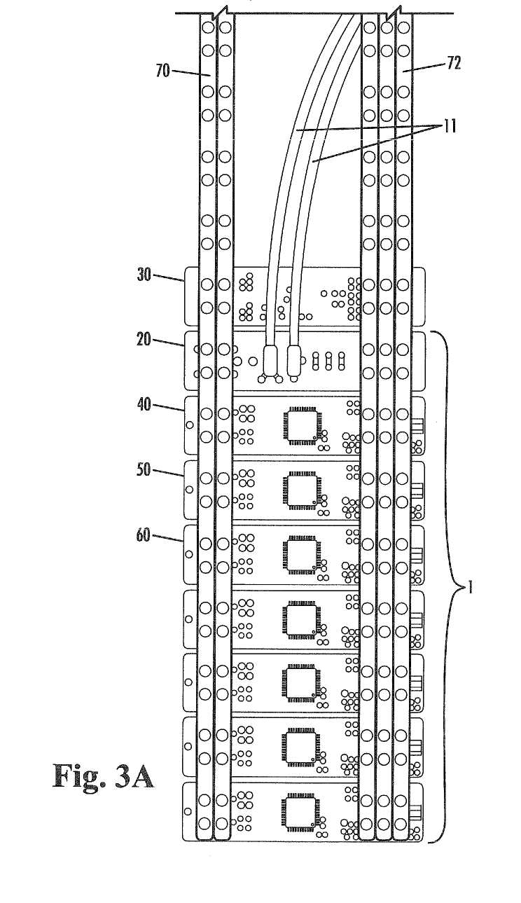

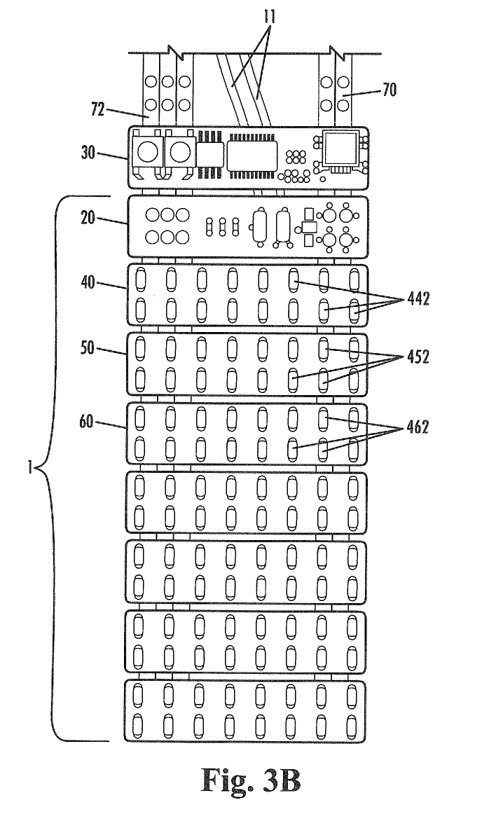

A more detailed process flow diagram is provided in FIG. 2. At step 100, the user activates the system via the user interface. The user interface (34) may include a depressible button, a rotatable knob, or the like, and may include multiple buttons or knobs for various adjustments to the display image and an LED or LCD screen for visual confirmation of the display settings. When the system is activated, the battery (10) provides electrical current to the terminal board (20), as reflected in step 110. Without user intervention, the terminal board (20) provides electrical current to the processor board (30) in step 120, via a flexible electrical connection (70, shown, e.g., in FIG. 3A). The flexible electrical connection 70 also conveys electrical current to each of the LED boards 40, 50, 60, etc.

Optionally, in step 102, the user may upload a converted file image into the system memory storage element (32). The memory storage element 32 may be provided with one or more pre-loaded display images. Alternately, or additionally, the user may create a customized display image, using software suitable for creating moving or static images. Examples of such software include the “Motion” program from Apple, Inc.; the “After Effects” program from Adobe Systems; and the “Combustion” program from Autodesk, Inc. (formerly Discreet). Once the file containing the display image is created, the user may then convert the image to the proper format for the display processor (30). The formatted file may be uploaded (as in step 102) via a USB cable connection between the user's personal computer and the processor board (30) or via a removable memory card, which is inserted into a receptacle in the processor board (30) (not shown). The complexity of the display image is limited only by the size of the display module (1) and the size of the memory storage element (32).

In step 134, the user may manipulate the user interface (34) to select the image to be displayed. Once selected, the processor (30) retrieves the file image data from the memory storage element (32), as shown in step 130. The processor (30) sends the file data, in the form of electronic signals, through the terminal board (20) to the driver (440) on the first light emitting (LED) board (40), via a second flexible electrical connection (72, shown in FIG. 3A), as reflected in step 136 of the process diagram.

The first driver, or driver #1, (440) receives electric current from the flexible electrical connection 70, which connects the first LED board 40 to the terminal board 20, and electronic data signals from the flexible electrical connection 72, which carries the signals, or instructions, from the processor board 30 through the terminal board 20 and to the first LED board 40. The first driver 440 modulates the current to the light emitting diodes (442) on the first light emitting board (40), as shown in step 140. As a result, each light emitting diode of the first set (442) responds individually, based on the electrical current received, as shown in step 142.

In step 148, the first driver (440) provides data to the second driver (540) on the second light emitting board (50), via the flexible electrical connection 72. Similarly to step 142, in step 152, the second driver (540) receives its electrical current from the electrical connection (70), which provides electricity to all of the LED boards collectively, and modulates the signals to each of the light emitting diodes in the LED set (542) on the second light emitting board (50).

In step 158, the second driver (540) conveys the data signals to the driver (640) of the third light emitting board (60). The third driver (640) performs in the same manner as the first and second drivers (440, 540) and selectively transmits electrical current to the light emitting diodes of the third light emitting board (60).

Each diode is independently directed, so that a given board (e.g., 40) may include diodes at full brightness, at various degree of partial brightness, and/or not illuminated, as may be practical to create a desired display image. Moreover, if the display image is a moving image, each diode may experience a different level of brightness over time. The independent control of each diode in a given board and of each board separate from the adjacent or subsequent boards offers a wide range of capability in the display images created, including a full range of gray scale or color images.

The process of sequential signal transfer from driver to driver of adjacent light emitting boards continues in this manner until all of the light emitting boards of a display have received signal instructions. Although three light emitting boards and corresponding signal transfers are shown in FIG. 2, it should be understood that different numbers of light emitting boards and drivers may be employed, based on design specifications. Thus, the signal transfer process is scalable to any number of light emitting boards, all of the light emitting boards being electrically connected by the electrical connection (72). It should also be understood that the flexible electrical connection 70, which provides current to the light emitting boards 40, 50, 60 may similarly be extended to any number of boards, as design specifications dictate.

FIGS. 3A and 3B illustrate the back and front, respectively, of the processor board 30 and a display module 1, which includes the terminal board 20 and a number of light emitting circuit boards 40, 50, 60, etc. The processor board 30 may be located in-line with the terminal board 20, as shown in FIGS. 3A and 3B, or may be located remotely from the terminal board 20, as shown in FIG. 4B.

The connection mechanism between the terminal board 20 and the first light board 40 and between the first light board 40 and the second light board 50, and so on, is a flexible electrical connection, such as a strip of flexible circuit board (72, as shown in FIG. 3A) or coated wires (35, as shown in FIG. 4A). By using a flexible connection, the display module 1 is afforded sufficient flexibility for most textile applications, as will be described herein, while the use of rigid circuit boards as carriers of the light emitting diodes results in greater durability and lower manufacturing costs as compared with display modules made primarily of flexible circuit boards.

The terminal board 20 includes a number of data connection ports, which are connected (via a strip of flexible circuit board 72, as shown in FIG. 3A, or wiring 35, as shown in FIG. 4B) to data connection ports on the processor board 30. The data signals originating from the memory storage element (32) are conveyed through the flexible electrical connection (flexible circuit board strip 72 or wires 35) to the terminal board 20, from which the signals are transferred through a second set of data connectors on the terminal board to a data-in connector on the first light emitting board 40. The signals then are carried from a data-out connector on the first light emitting board 40 to a data-in connector on the second light emitting board 50, before being carried from a data-out connector to a third light emitting board 60, and so forth.

The terminal board 20 further is provided with a pair of electrical input ports for receiving electrical current from coated wires 11 connected to the battery (10). The terminal board 20 transmits electricity from its electrical outlet ports through flexible electrical connection 70 to both the processor board 30 and the light boards 40, 50, etc. Each light board 40, 50, etc. has a positive voltage port and a negative voltage port, ensuring the proper polarity is maintained as the boards are connected. As before, the use of a flexible electrical connection (such as the flexible circuit board 70) provides the assembled display module 1 with a high degree of flexibility.

FIG. 3B shows the display module 1 and the processor board 30. The display module 1 features a first terminal board 20 at one end, a number of light emitting circuit boards 40, 50, 60, etc. on which a plurality of light emitting diodes 442, 542, 642, respectively, are mounted. The flexible circuit board strip 70 carries electrical current from the terminal board 20 to the light emitting circuit boards 40-60+, while the flexible circuit board strip 72 carries data signals to the light emitting circuit boards 40-60+. Conventional wiring may be used in place of either of the flexible circuit boards 70, 72, if so desired.

The back side of a larger display module 1 is illustrated in FIG. 4A, which features twenty light emitting boards oriented sequentially between a pair of terminal boards 20, 20′. The light emitting boards 40, 50, etc. and the terminal boards 20, 20′ are connected to one another by strips of flexible circuit board (70, 72), as described above. The terminal board 20 is connected by wires 35 to the processor board (30) and by a different set of wires 11 to the battery 10.

FIG. 4B shows the display module 1 of FIG. 4A from the front (light-emitting) side, as part of an electronic display system 1000. With sixteen LEDs per circuit board, the twenty light emitting circuit boards provide 320 individually controllable light emitting diodes for a full range of gray scale display images. Other numbers of LEDs may instead be used, with a typical design including around 500 LEDs.

The processor board 30 includes the user interface 34 and a LCD or LED screen 36 to facilitate the selection and/or modification of a stored display image. The user interface 34, as shown, has four depressible buttons, which may be programmed to provide different functionality. Different numbers or types of knobs, switches, buttons, or the like may instead be used, depending on the complexity of the display module system 1000.

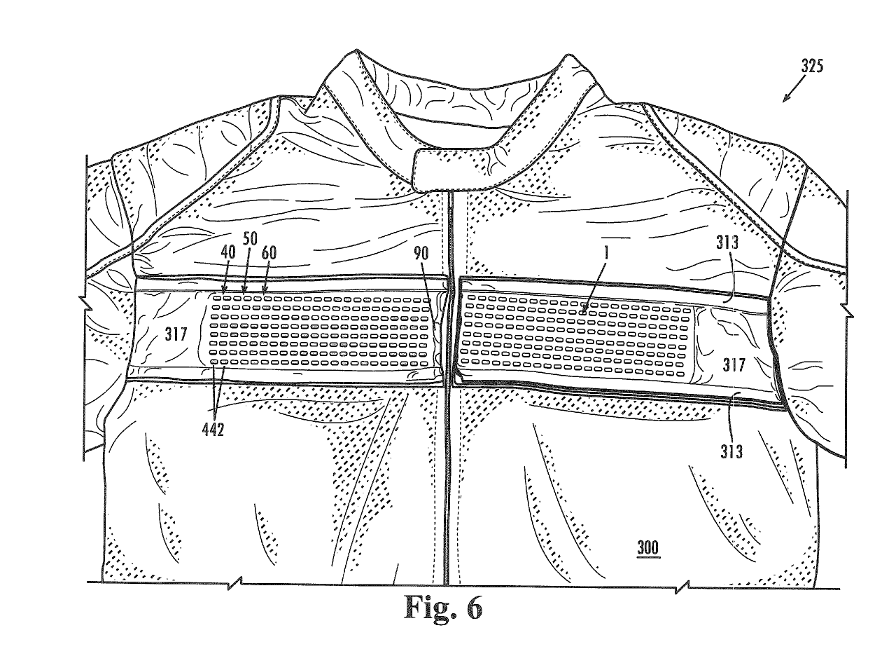

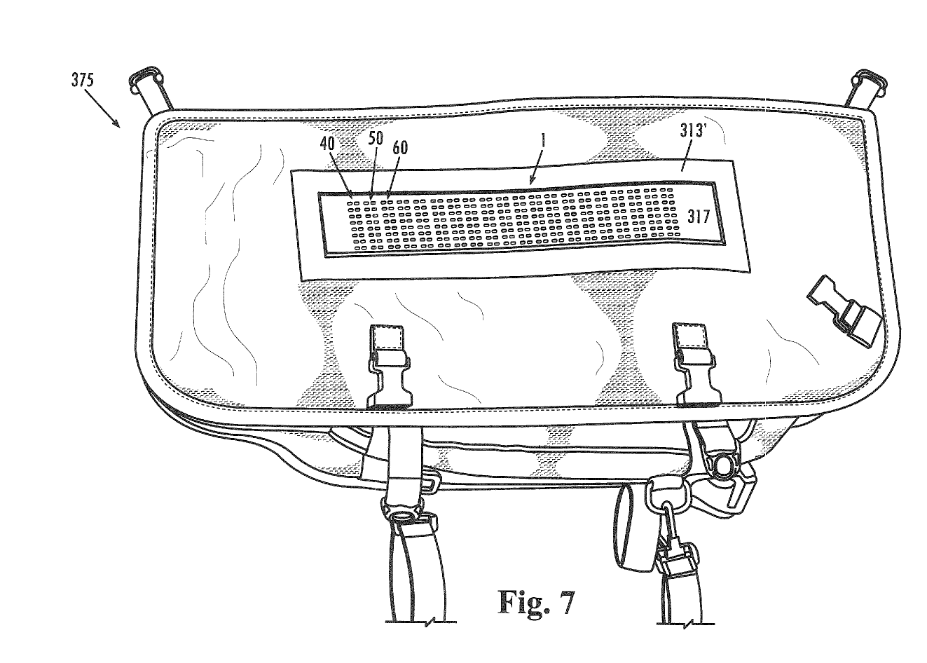

The present display system 1000 is configured to illuminate a textile article to be worn or carried, such as those shown in FIGS. 6 and 7. By way of example, but not to be limited to, a textile article to be worn may be one of a jacket, a coat, a shirt, a pair of pants, shorts, a skirt, a vest, a hat, a dress, a sash, a collar, a tie, and the like. A textile article to be carried may include, but not be limited to, a tote bag, a duffle bag, a messenger bag, a diaper bag, an instrument case, a suitcase, a backpack, a handbag, a pet crate, and the like.

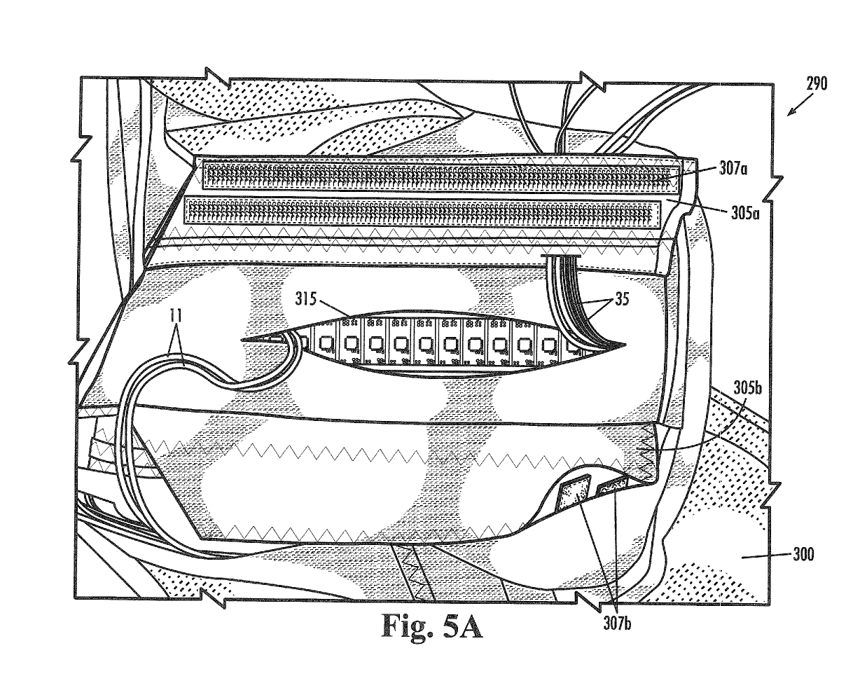

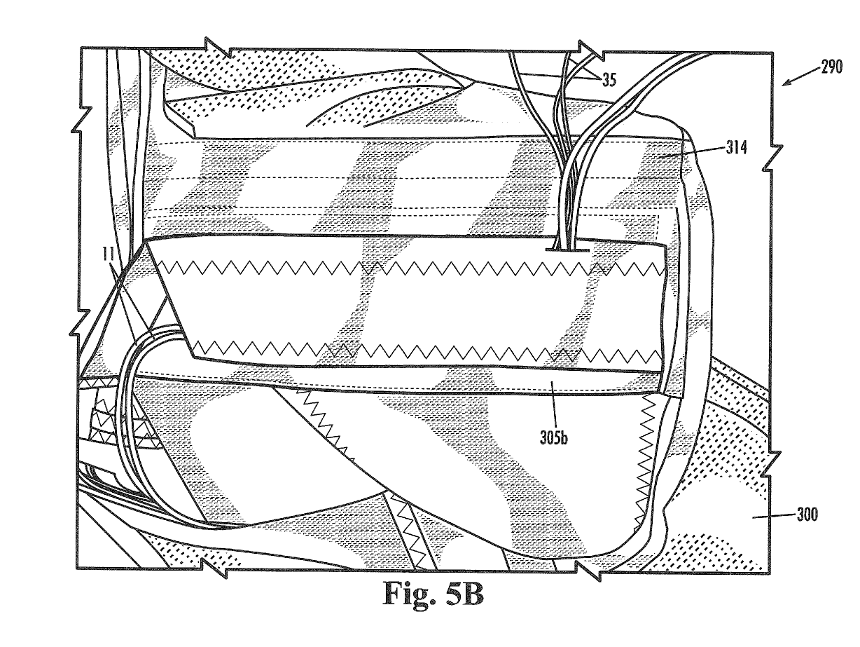

Whether the article is to be worn or carried, the textile substrate 300 comprising the article is provided with a pocket 290 to hold the display module 1 (as shown in FIGS. 5A and 5B). The purpose of the pocket 290 is not only to prevent the display module 1 from being damaged by dirt, liquid (from rain or a spilled beverage), or incidental contact, but also provide a mechanism for removing the display module 1 so that the article itself may be cleaned or laundered.

FIG. 5A illustrates the pocket 290 in an open orientation, revealing a slit 315 in the textile substrate 300. A light-transmitting cover surface (90) is secured to an outer surface of the textile substrate 300, for example, using seams 313 (as shown in FIG. 6). The seams 313 may be sewn or may be formed with an adhesive or other closure elements. The light-transmitting cover surface (90) may be any relatively durable sheet material capable of transmitting light therethrough, whether transparent or translucent, and including, but not limited to, a vinyl material, a plastic material, and a textile material, such as a chiffon. Further, more than one layer of the light-transmitting cover surface (90) may be used to achieve different levels of diffusion, and different combinations of materials may also be employed (for instance, a textile layer and a vinyl layer).

A slit 315 is formed in the textile substrate 300 to permit the entry or removal of the display module 1, a portion of the light emitting boards being shown within the slit 315. To the inner surface of the textile substrate 300, a pair of pocket flaps 305a, 305b are secured, via seams 314. The pocket flaps 305a, 305b are provided to reinforce the pocket 290 and are outfitted with a closure element 307a, 307b, respectively, to join the support layers 305a, 305b together and to thereby close the interior side of the pocket 290. The closure elements 307a, 307b are illustrated as a hook-and-loop closure system (such as is marketed under the tradename “VELCRO”® fasteners), although other closure elements may instead be used, including hook-and-eye fasteners, snaps, zippers, buttons, and the like.

In an alternate construction (not shown), the light-transmitting cover surface (90) is attached, along all but one side thereof, to the outer surface of the textile substrate 300 by sewn seams 313. Along the non-attached side of the pocket, a reclosable seam is formed, such as may be created by attaching one side of a hook and loop fabric 307a to the cover surface 90 and attaching the opposite side of a hook-and-loop fabric 307b to the textile substrate 300. This reclosable opening permits the display module 1 to be slid into and out of the pocket easily. Depending on the location of the pocket relative to the article, it may be necessary to form a small slit in the textile substrate 300 proximate an end of the pocket to permit the flexible electrical connections to be located on the inner surface of the textile substrate 300.

FIG. 6 illustrates a jacket 325 into which a display system (1000) has been integrated. The display module 1—including light emitting boards 40, 50, 60, etc.—is visible through a light-transmitting cover surface 90 of the pocket 290, which has seams 313 around the perimeter thereof. If desired, a shielding panel 317 of textile material having the same approximate color as the textile substrate may be joined to the interior of the light-transmitting cover surface 90 at either end of the pocket 290 to hide the non-lighting terminal board(s) 20 (20′). Alternately, or in addition, the terminal boards (20, 20′) may be colored to match the textile substrate and to camouflage their appearance.

In the case of the jacket 325, the display module 1 is bisected by the jacket's zipper into two separate segments, each having its own terminal board (20). A wiring harness is used to distribute electrical current to the separate segments. A pair of highly flexible, heavy gauge wires are positioned along the interior seams of the jacket 325 at strategic load-bearing points, such as adjacent the zipper, adjacent the jacket's side seams, and/or adjacent or within the collar. These heavy gauge wires are then connected to the terminal boards (20, 20′) via insulation-displacement, tap-splice connectors.

The separate segments each include light emitting circuit boards positioned between terminal boards. Data signals are conveyed from the processor board (30) to the first segment by passing through the first terminal board, the plurality of light emitting circuit boards, and through the second terminal board. The “exit” terminal board of the first segment is attached to an “entry” terminal board of the second segment, and the data signals are cascaded from the “entry” terminal board through the second plurality of light emitting circuit boards to a final terminal board. The data signals may be looped back to the processor board, if desired, although not required. It should be understood that the display module 1 may be located at other areas of the jacket 325, including the back, the collar, the sleeves, and/or the cuffs.

The battery (10) and the processor board (30) may be conveniently located in a pre-fabricated pocket of the jacket 325, or a specially configured pouch (not shown) may be created to house the battery (10) and the processor board (30). The battery (10) and processor board (30) conveniently may be installed on the interior (inwardly facing) surface of the textile substrate, so as to be hidden from view. In one instance, the battery pouch may be located along the interior rear panel of the jacket 325.

FIG. 7 illustrates one representative article to be carried by a user thereof, in this instance, a messenger bag 375. The messenger bag 375 is provided with a pocket 290 in which the seam area 313′ is made of a durable material, such as vinyl, rubber, leather, or the like material. The display module 1 is housed within the pocket 290, while the battery (10) and the processor board (30) are stored within the bag 375 itself. Conveniently, many of such bags include internal pockets for storage, though a special pouch may be configured for such purpose if needed.

Although the present display modules 1 have been shown as having a substantially rectangular shape with a longer length than width, other shapes may also be used. For example, the light emitting boards (e.g., 40) may be formulated in a different shape, such as a square, which may then be arranged as a grid. Alternately, the light emitting boards may be arranged in a different pattern, such as radially.

The preceding discussion merely illustrates the principles of the present portable electronic display system. It will thus be appreciated that those skilled in the art will be able to devise various arrangements, which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the inventions and the concepts contributed by the inventor(s) to furthering the art and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawings, which are to be considered part of the entire description of the invention. In the description, relative terms such as “lower”, “upper”, “horizontal”, “vertical”, “above”, “below”, “up”, “down”, “top” and “bottom”, as well as derivatives thereof (e.g., “horizontally”, “downwardly”, etc.) should be construed to refer to the orientation as then described or as shown in the drawing under discussion. These relative terms are for convenience of description and do not require that the apparatus be constructed or operated in a particular orientation, unless otherwise indicated. Terms concerning attachment, coupling, and the like, such as “connected”, “attached”, or “interconnected”, refer to a relationship wherein structures are secured or attached to one another either directly or indirectly through intervening structures, as well as both movable or rigid attachments or relationships, unless expressly described otherwise.

The foregoing description provides a teaching of the subject matter of the appended claims, including the best mode known at the time of filing, but is in no way intended to preclude foreseeable variations contemplated by those of skill in the art. Such variations, therefore, are considered to be covered by the appended claims.

I claim:

1. A portable electronic display system comprising:
a display module, the display module comprising a rigid printed circuit board having an LED driver, a plurality of light emitting diodes arranged linearly and attached to the printed circuit board, and a terminal board in proximity to the printed circuit board and in communication with the LED driver, the printed circuit board being arranged sequentially with the terminal board;
a processor board including a memory storage element, the processor board being in communication with the terminal board of the display module;
means for flexibly connecting the terminal board to the printed circuit board and to the processor board;
a textile substrate, the textile substrate having an inner surface and an outer surface, the outer surface being configured with a pocket having a light-transmitting cover surface, wherein the display modules are housed within the pocket, such that the light emitting diodes are adjacent the light-transmitting cover surface; and
a battery, the battery being in electrical communication with the terminal board and being located proximate to the textile substrate;
wherein the memory storage element provides instructions to the LED driver to selectively control the light emitting diodes and thereby produce an updateable display image.

2. The electronic display system of claim 1, wherein the display system produces a moving display image.

3. The electronic display system of claim 1, wherein the light emitting diodes are single color diodes.

4. The electronic display system of claim 1, wherein the light emitting diodes are multi-color diodes.

5. The electronic display system of claim 1, wherein the light emitting diodes have a brightness of about 80 to about 300 millicandelas.

6. The electronic display system of claim 1, wherein the flexible connection means are wires.

7. The electronic display system of claim 1, wherein the flexible connection means are flexible printed circuit boards.

8. The electronic display system of claim 1, wherein the memory storage element is a permanent memory storage unit and is located on the processor board.

9. The electronic display system of claim 1, wherein the memory storage element is a removable memory card.

10. The electronic display system of claim 1, wherein the light-transmitting cover surface of the pocket is one of a vinyl material, a plastic material, and a textile material.

11. The electronic display system of claim 1, wherein the light-transmitting cover surface of the pocket is a chiffon.

12. The electronic display system of claim 1, wherein the pocket is provided with a reclosable opening opposite the light-transmitting cover surface, the reclosable opening being a slit through which the display modules may be conveyed.

13. The electronic display system of claim 11, wherein the reclosable opening in the pocket is provided with one of a hook-and-loop closure, a hook-and-eye closure, a snap closure, a button, and a zipper.

14. The electronic display system of claim 11, wherein the reclosable opening in the pocket is provided with a hook-and-loop closure.

15. The electronic display system of claim 1, wherein the processor board is provided with at least one user interface that allows a user to selectively alter the display image on the display module.

16. The electronic display system of claim 1, wherein the battery is portable and wherein the inner surface of the textile substrate comprises a pouch, the pouch being configured for holding the battery.

17. The electronic display system of claim 1, wherein the textile substrate comprises an article to be worn by a user thereof.

18. The electronic display system of claim 17, wherein the article to be worn is selected from the group consisting of a jacket, a coat, a shirt, a pair of pants, shorts, a skirt, a vest, a hat, a dress, a sash, a collar, and a tie.

19. The electronic display system of claim 1, wherein the textile substrate comprises an article to be carried by a user thereof.

20. The electronic display system of claim 19, wherein the article is selected from the group consisting of a tote bag, a duffle bag, a messenger bag, a diaper bag, an instrument case, a suitcase, a backpack, a handbag, and a pet crate.

21. An electronic display system comprising:
a display module, the display module comprising a rigid printed circuit board having an LED driver, a plurality of light emitting diodes attached to the printed circuit board, and a terminal board in proximity to the printed circuit board and in communication with the LED driver, the printed circuit board being arranged sequentially with the terminal board;
a processor board including a memory storage element, the processor board being in communication with the terminal board of the display module;
a flexible printed circuit board connecting the terminal board to the rigid printed circuit board and to the processor board;
a textile substrate, the textile substrate having an inner surface and an outer surface, the outer surface being configured with a pocket having a light-transmitting cover surface, the pocket being configured to house the display module, such that the light emitting diodes are adjacent the light-transmitting cover surface; and
a battery, the battery being in electrical communication with the terminal board and being located proximate to the textile substrate;
wherein the memory storage element provides instructions to the LED driver to selectively control the light emitting diodes and thereby produce an updateable display image.
